(19) United States
(12) Patent Application Publication
(10) Pub. No.: US 2025/0292957 A1
(43) Pub. Date: Sep. 18, 2025

(54) TRANSFORMER

(71) Applicant: Coilcraft Inc., Cary, IL (US)

(72) Inventors: Kurt D. Smith, Crystal Lake, IL (US); Jeffrey J. Finch, Cary, IL (US)

(21) Appl. No.: 18/606,240

(22) Filed: Mar. 15, 2024

(51) Int. Cl. H01F 30/06; H01F 27/30; H01F 38/20; H01F 41/064; H01F 41/12

(52) U.S. Cl. CPC H01F 30/06; H01F 27/306; H01F 41/064; H01F 41/127; H01F 38/20

(57) ABSTRACT

According to an embodiment, a transformer includes: a core including a winding portion comprising a first end and a second end; a primary winding proximate the first end of the winding portion of the core, wherein the primary winding includes a wire comprising a U-shape, a first primary winding end, and a second primary winding end, wherein the first primary winding end comprises a first primary terminal, and the second primary winding end comprises a second primary terminal; and a secondary winding proximate the second end of the winding portion of the core, wherein the secondary winding includes a wire forming a plurality of turns, a first secondary winding end, and a second secondary winding end, wherein the first secondary winding end comprises a first secondary terminal, and wherein the second secondary winding end comprises a second secondary terminal.

### CROSS REFERENCE TO RELATED APPLICATIONS

[Not Applicable]

### BACKGROUND

Generally, this application relates to transformers, such as those used in current sensing circuits.

### SUMMARY

According to embodiments, a transformer includes: a core including a winding portion comprising a first end and a second end; a primary winding proximate the first end of the winding portion of the core, wherein the primary winding includes a wire comprising a U-shape, a first primary winding end, and a second primary winding end, wherein the first primary winding end comprises a first primary terminal, and the second primary winding end comprises a second primary terminal; and a secondary winding proximate the second end of the winding portion of the core, wherein the secondary winding includes a wire forming a plurality of turns, a first secondary winding end, and a second secondary winding end, wherein the first secondary winding end comprises a first secondary terminal, and wherein the second secondary winding end comprises a second secondary terminal. The transformer may further include a first lateral portion of the core and a second lateral portion of the core, a first attachment portion coupling the first secondary winding end to the second lateral portion of the core, and a second attachment portion coupling the second secondary winding end to the second lateral portion of the core. The first attachment portion and the second attachment portion may include welds. The first primary winding end and the second primary winding end may not be coupled with the core. The wire of the primary winding may be substantially rigid. The plurality of turns of the wire of the secondary winding may include between two and eight layers. The wire of the secondary winding may include between 20 and 200 turns. The core may further include a first lateral portion coupled with the first end of the winding portion, a second lateral portion coupled with the second end of the winding portion, and an upper portion, wherein the upper portion is coupled with the first lateral portion and the second lateral portion. A first gap may be formed between the upper portion and the first lateral portion in a coupling region between the upper portion and the first lateral portion; and a second gap may be formed between the upper portion and the second lateral portion in a coupling region between the upper portion and the second lateral portion. The first gap and the second gap may each be between 0.02-0.10 mm.

According to embodiments, there is a method for constructing a transformer, the transformer including a core, wherein the core comprises a winding portion having a first end and a second end, a first lateral portion coupled with the first end of the winding portion, and a second lateral portion coupled with the second end of the winding portion, a primary winding, and a secondary winding, the method comprising: placing a primary winding over a winding portion of the core proximate the first end of the winding portion, wherein the primary winding includes a wire including a U-shape, a first primary winding end, and a second primary winding end; and winding a secondary winding around the winding portion of the core proximate the second end of the winding portion, wherein the secondary winding includes a wire forming a plurality of turns, a first secondary winding end, and a second secondary winding end, wherein there is no upper portion of the core coupled with the first lateral portion and the second lateral portion when performing said placing the primary winding over the winding portion of the core and said winding the secondary winding around the winding portion of the core. After said placing the primary winding over the winding portion of the core, and after said winding the secondary winding around the winding portion of the core, the upper portion of the core may be coupled with the first lateral portion of the core, and the upper portion of the core may be with the second lateral portion of the core. When the upper portion of the core is coupled with the first lateral portion of the core and the second lateral portion of the core, a first gap may be formed between the upper portion of the core and the first lateral portion of the core, and a second gap may be formed between the upper portion of the core and the second lateral portion of the core, wherein each of the first gap and the second gap may be between 0.02 and 0.10 mm. The method may further include encasing, with an overmold, at least a portion of the core, a portion of the primary winding, and a portion of the secondary winding, wherein the first primary winding end, the second primary winding end, the first secondary winding end, and the second secondary winding end are not encased by the overmold. The overmold may include a magnetic composite material. The method may further include coupling the first secondary winding end and the second secondary winding end with the second lateral portion of the core. Said coupling the first secondary winding end and the second secondary winding end with the second lateral portion of the core may include welding the first secondary winding end and the second secondary winding end to the second lateral portion of the core. The first primary winding end and the second primary winding end may not be coupled with the core. Said winding the secondary winding around the winding portion of the core may further include: winding a first layer around the core; and subsequently winding a second layer around the first layer. The wire of the primary winding may be substantially rigid.

### BRIEF DESCRIPTION OF SEVERAL VIEWS OF THE DRAWINGS

FIG. 1A illustrates a perspective view of a transformer, according to embodiments.

FIG. 1B illustrates a perspective view of a transformer, according to embodiments.

FIG. 2 illustrates an exploded view of a transformer, according to embodiments.

FIG. 3 illustrates a front elevation view of a transformer, according to embodiments.

FIG. 4 illustrates a cross-section view of a transformer taken along the plane indicated by the line shown by 4-4 in FIG. 1B, according to embodiments.

FIG. 5 illustrates a bottom plan view of a transformer, according to embodiments.

FIG. 6 illustrates a circuit diagram including a transformer, according to embodiments.

FIG. 7 illustrates a flowchart for a method of assembling a transformer, according to embodiments.

The foregoing summary, as well as the following detailed description of certain techniques of the present application, will be better understood when read in conjunction with the appended drawings. For the purposes of illustration, certain techniques are shown in the drawings. It should be understood, however, that the claims are not limited to the arrangements and instrumentality shown in the attached drawings. Furthermore, the appearance shown in the drawings is one of many ornamental appearances that can be employed to achieve the stated functions of the system.

### DETAILED DESCRIPTION

According to embodiments, construction of a transformer can be simplified. The transformer may have two windings. The primary winding may be relatively stiff and have a U-shape. The secondary winding may be flexible wire. The core may have an upper portion, but it may be attached later in the construction process. For example, the upper portion of the core may be attached after the primary winding has been placed on the core and after the secondary winding has been wound around the core. By waiting to attach the upper portion of the core until after the primary winding and the secondary winding have been arranged on the core, manufacturing can be simplified. For example, it may not be necessary to use a bobbin to wind the secondary winding around the core.

Further, the primary winding may be self-terminating, where no interconnect is needed to connect the primary winding to a printed circuit board. This may allow or facilitate for the conductor in the primary winding to have a larger cross-sectional area. A larger cross-sectional area allows higher current flow through the primary winding.

Further, the dimensions of the core may be selected to enhance the system to have sufficient volt-time product when the target magnetizing inductance is achieved. Obtaining target magnetizing inductance may allow for effective current sensing to be achieved in the frequency spectrum of most interest to a given application.

The transformer may have a relatively small footprint, and may be usable for a number of applications, such as current sensing, energy harvesting, or other high delta voltage step up applications.

As used herein, the term “between” connotes that the endpoints of numerical ranges are included.

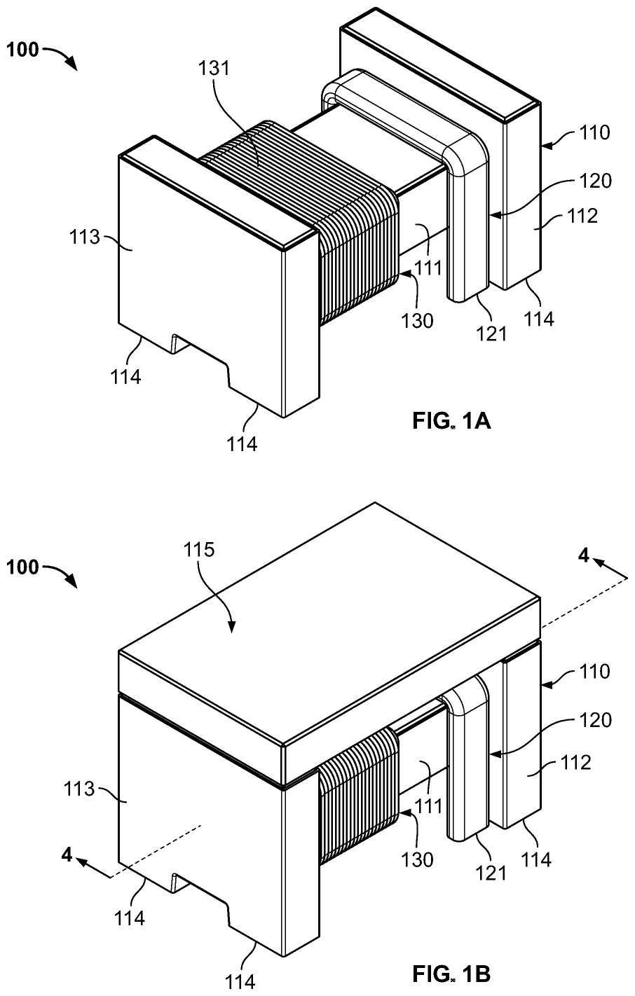

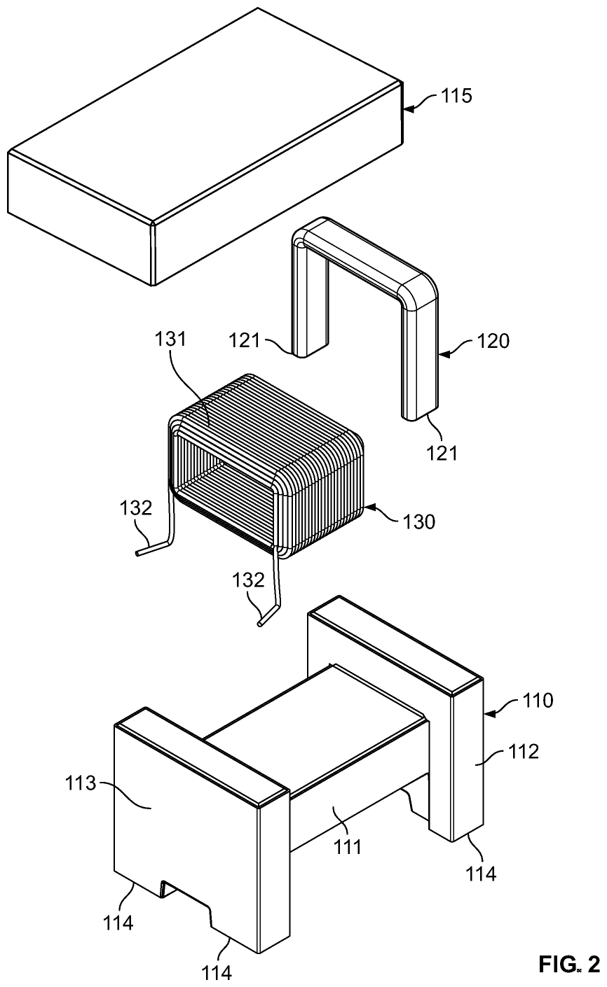

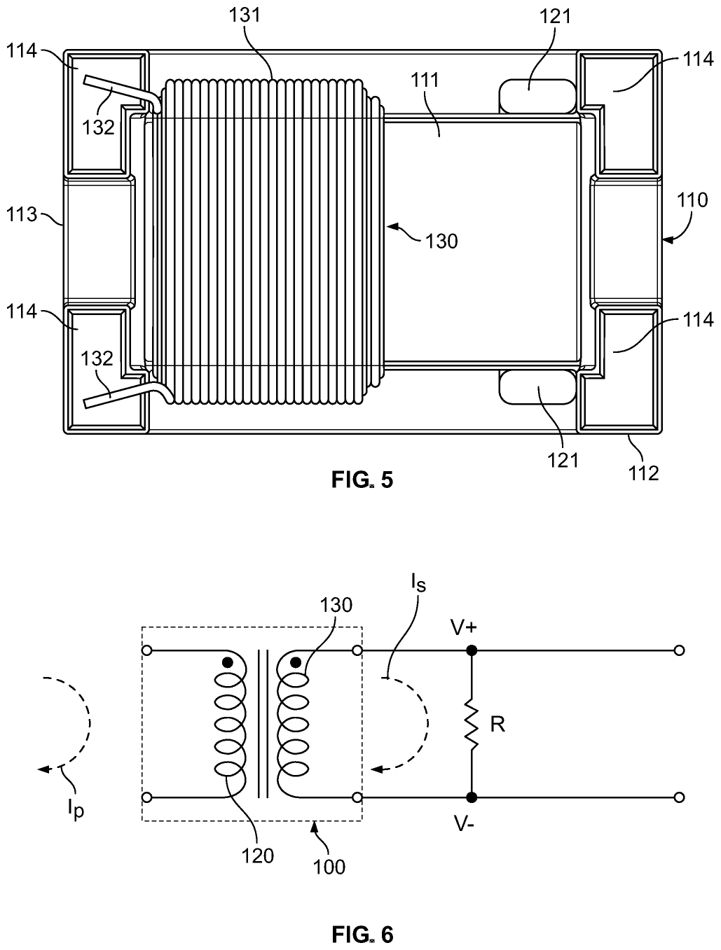

FIGS. 1A, 1B, 2, 3, 4, 5, and 6 illustrate different views and embodiments of a transformer 100. The transformer 100 may include a core 110, a primary winding 120, and a secondary winding 130. The transformer 100 may further include adhesive(s) and/or an overmold, neither of which are depicted in the figures.

The core 110 may further include a winding portion 111, a first lateral portion 112, a second lateral portion 113, and an upper portion 115. One or more portions of the core 100 may include or be comprised of a material such as ferrite or other magnetic material. The winding portion 111 of the core 100 may include a first end proximate to or abutting the first lateral portion 112. The winding portion 111 of the core 110 may include a second end proximate to or abutting the second lateral portion 113. The winding portion 111 of the core 110 may be a separate portion from the first lateral portion 112 and/or the second lateral portion 113. The winding portion 111 of the core 110 may attach to or be coupled with the first lateral portion 112 and/or the second lateral portion 113. The winding portion 111 of the core 110 may be integrated with the first lateral portion 112 and/or the second lateral portion 113. The winding portion 111 of the core 110 may have a width of between 1.5-4.0 mm, such as 3.0 mm in the region between the first lateral portion 112 and the second lateral portion 113. The winding portion 111 of the core 110 may have a height of between 1.0-3.0 mm, such as between 1.0-1.5 mm, in the region between the first lateral portion 112 and the second lateral portion 113. The winding portion 111 of the core 110 may have a depth of between 0.5-2.0 mm, such as between 0.5-1.5 mm, in the region between the first lateral portion 112 and the second lateral portion 113. The winding portion 111 of the core 110 may have an outer surface shaped as with a rectangular solid, a cylindrical solid, or a different shape. The winding portion 111 may have a length of between 1.0-8.0 mm, such as between 4.0-6.0 mm. The length of the winding portion 111 may influence the amount of isolation between the primary side of the transformer 100 and the secondary side of the transformer 100. A shorter winding portion 111 (e.g. 1.0-3.0 mm, such as between 1.5-2.0 mm) may be suitable for low-voltage applications, such as certain current-sensing applications, whereas a longer winding portion 111 (e.g., 3.0-8.0 mm, such as between 4.5-6.0 mm) may be suitable for higher-voltage applications, such as battery pack applications.

The first lateral portion 112 of the core 110 may include one or more feet 114 (two are shown). The second lateral portion 113 of the core 110 may include one or more feet 114 (two are shown). One or more of the feet 114 may be configured to mechanically contact a substrate (e.g., a printed circuit board, or PCB) when the transformer 100 is included in a circuit or device. As shown, there is a recessed area between the feet 114 on both of the first lateral portion 112 and the second lateral portion 113 of the core 110. The recessed area between the feet 114 may provide improved isolation between the start and finish of the winding. One or more of the feet 114 may have a lower surface having a width of between [0.4-2.0 mm] and a depth of between 0.4-2.0 mm, such as between 0.5-1.0 mm. The lower surface(s) of the feet 114 may be substantially or completely flat and may optionally include one or more recesses. For example, as will be further discussed, such recesses in the feet 114 on the second lateral portion 113 may accommodate some or all of the end(s) 132 (e.g., the height and/or length of the end(s) 132) of the secondary winding 130. The feet 114, for example the feet 114 in the second lateral portion 113 may be metalized or have a metal portion on the lower surface. Such metallization or a metal portion may facilitate connection of the end(s) 132 to the feet 114, as further described herein. The first lateral portion 112 and the second lateral portion 113 of the core 110 may have respective upper surfaces, one or both of which may couple with the upper portion 115 of the core 110.

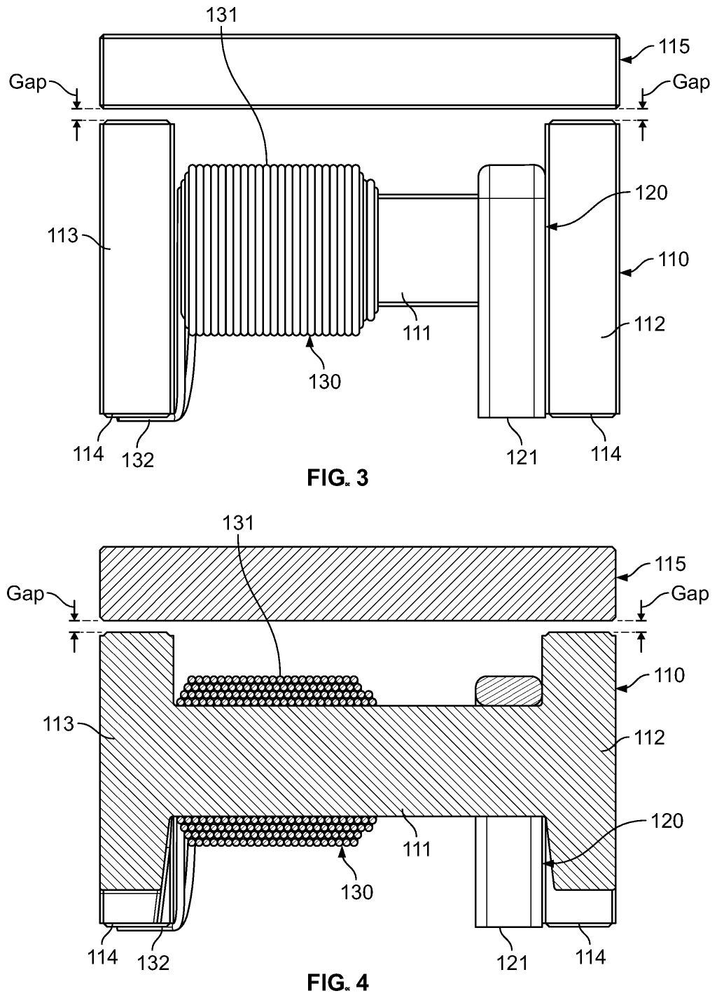

The upper portion 115 of the core 110 may provide a return path for the magnetic flux. The upper portion 115 of the core may have a width of between 2.0-6.0 mm, such as between 3.0-5.0 mm, a height of between 0.5-2.0 mm, such as 1.0 mm, and/or a depth of between 3.0-9.0 mm, such as between 7.0-8.0 mm. The each of the lower surface and/or upper surface of the upper portion 115 may have a surface area of between 6.0-54.0 mm², such as between 28-35 mm². The upper portion 115 of the core 110 may be coupled with the first lateral portion 112 and/or the second lateral portion 113. For example, the upper portion 115 of the core may be adhered to one or both of the first lateral portion 112 and the second lateral portion 113 (e.g., on an upper surface of the first lateral portion 112 and/or the second lateral portion 113). Alternatively, a non-adherent material may be interposed in the coupling region of the first lateral portion 112 and the upper portion 115 and/or the coupling region of the second lateral portion 113 and the upper portion 115. When the upper portion 115 is coupled to the first lateral portion 112, a gap between the portions 112, 115 may be formed (see, e.g., FIGS. 3 and 4, in which the gaps are not necessarily to scale). For example, an epoxy or other filler or buffer material or other type of spacer may be used to form or maintain the gap(s). Other examples of a spacer include adhesives, tapes, or cement. The gap(s) may have a height of between 0.02-0.10 mm. Minimizing or reducing the gaps may improve magnetizing inductance, which may beneficial to applications such as voltage step up, current sensing, or the like.

The upper portion 115 of the core 100 may be assembled with the transformer 100 after the primary winding 120 and/or secondary winding 130 have been wound or placed on the core 110. Such a technique may simply assembly of the transformer 100. For example, the secondary winding 130 may be wound this way without the use of a bobbin or similar winding apparatus.

According to embodiments, the upper portion 115 of the core 110 may be omitted or not included in the transformer 100. According to embodiments, the transformer 100 may include an overmold (not shown). An overmold may encase the transformer 100, except for at the lower surface of the transformer 100 where the transformer 100 couples to a substrate (e.g., PCB). For example, according to one embodiment, the transformer 110 does not include the upper portion 115 of the core 110 and includes an overmold.

The overmold may be a material with either composite or ferrite magnetic material or a mix thereof. The overmold may be a mix of magnetic powder (ferrite or magnetic composite powder) with a binder. The powder granules for the magnetic powder may have an average or specific diameter between 1-100 μm or up to 900 μm. The powder granules for the binder may have an average or specific diameter between 1-100 or up to 900 μm. The binder may melt during the molding process and later be processed, resulting in a substantially solid overmold. The ratio of magnetic material to binder may be between 85%: 15% to 98%: 2% by weight. The binder may be thermoplastic, thermoset, epoxy or other material that suitably melts and then can be cured or baked to form a molded body. The binder may be a mix of suitable materials. The overmold may be formed by injection, compression, transfer molded, or a combination thereof.

The primary winding 120 may be wound at least partially around the winding portion 111 of the core 110. The primary winding 120 may not fully encircle the winding portion 111 of the core 110 (as shown in the depicted embodiments). In this case, it is understood that the primary winding 120 has a single turn. The primary winding 120 may be vertically oriented, and may have a staple shape or a U-shape (as shown). The conductor of the primary winding 120 may have a thickness of between 0.1-1.5 mm, such as between 0.3-0.5 mm. The conductor of the primary winding 120 may have a length of between 0.5-3.0 mm, such as between 1.0-1.2 mm. The dimension(s) of the primary winding 120 may impact its inductance and resistivity (DCR). The primary winding 120 may have an inductance between 100-500 nH, such as between 120-200 nH. The inductance of the primary winding 120 may have a tolerance of +/−5% to +/−50%, such as between 10-25%. The primary winding 120 may have a DC resistance (DCR) between 0.05-10 mΩ, such as between 0.3-0.8 mΩ, along its length. The primary winding 120 may include a material, such as copper, silver, or aluminum. The primary winding 120 may be formed from a relatively stiff material that is bendable into different shapes.

In the case that the primary winding 120 has a staple shape or a U-shape (as shown), having an open end in a lower region of the primary winding 120, the open end of the primary winding 120 may be placed as one pre-formed piece over the winding portion 111 of the core 110. The primary winding 120 may be located proximate the first end of the winding portion 111 of the core 110. The primary winding 120 may be located proximate the lateral portion 112 of the core 110. Optionally, the primary winding 120 may abut the lateral portion 112 of the core 110. The primary winding 120 may have ends 121, which may be located in a corresponding end region. One or both of the ends 121 of the primary winding 120 may have a lower surface that is substantially flat. The ends 121 of the primary winding 120 may be terminals. When the transformer 100 is included in a circuit or device, the end(s) 121 of the primary winding 120 may be self-terminating in that there may be no need for interconnect(s). For example, the end(s) 121 of the primary winding 120 may be soldered directly to a substrate, such as to contact(s) on a PCB. In such a manner, the end(s) may be self-terminating, in that no interconnect is required to electrically couple the end(s) to corresponding contact(s) on the PCB.

The secondary winding 130 may be located proximate the second end of the winding portion 111 of the core 110. The secondary winding 130 may be located such that a gap is formed between the secondary winding 130 and the primary winding 120. Such a gap may be between 0.1-2.0 mm, such as between 1.0-1.5 mm.

The secondary winding 130 may include a plurality of windings 131 and ends 132. The secondary winding 130 may include a conductor, and formed of a material such as copper or copper-clad aluminum. The conductor may be insulated, for example, by a material such as polyester. The secondary winding 130 may include a plurality of layers (e.g., 2-8 layers, or 2-10 layers, or 2-12 layers; four layers are depicted (see FIG. 4)). The secondary winding 130 may include a plurality of turns, such as between 10-300 turns or 20-150 turns or 50-200 turns. The number of turns in each layer may be between 10-40. The secondary winding 130 may be wound directly onto the winding portion 111 of the core 110 (the innermost layer of the abuts core portion 110), or there may be an intermediate structure or material between the secondary winding 130 and the winding portion 111 of the core 110. The secondary winding 130 may extend between two ends 132. The secondary winding 130 may be wound in a number of turns or windings 131 around the winding portion 111 of the core 110 (e.g., proximate the second lateral portion 113). The secondary winding 130 may be wound starting from a first end 132. Turns in a first layer of the windings 131 may be formed by winding the conductor around the winding portion 111 of the core 110. The plurality of windings 131 are added, progressing from a region proximate the second lateral portion 113 of the core 110, and extending width-wise along the winding portion 111 of the core towards the first lateral portion 112 of the core 110. The turns in the plurality of windings 131 may be spaced from each other at a constant distance. In other words, the distance between the first and second turn in the first layer may be the same as the distance between the second and third turn in the first layer.

At some point, the direction of winding of the secondary winding 130 is reversed, such that one turn in the first layer directly faces the primary winding 120. Turns are then added in a second layer outside of the first layer, such that one turn in second layer is directly facing the primary winding 120. Turns are added in second layer, extending towards the second lateral portion 113. Turns in the second layer may be spaced from each other at a constant distance. Turns in the second layer may be directly on top of turns in the first layer, or turns may be staggered between the first layer and the second layer (as depicted, such as completely or partially staggered). The constant distance between turns in the first layer and turns in the second layer may be the same. After finishing the second layer, additional layers (e.g., third and fourth layers, fifth and sixth layers, etc.) may be added in a similar manner. Whether or not additional layers are added, after the final turn is wound around the winding portion 111 of the core 110, the conductor of the secondary winding 130 extends to an end 132.

The ends 132 may be positioned at least partially (or completely) under the second lateral portion 113 of the core 110. For example, each end 132 may be under a respective foot 114 of the second lateral portion 113 of the core 110, either partially or completely. Each foot 114 in the second lateral portion 113 may include a recess (or not) to receive a respective end 132. The ends 132 may be directly soldered or otherwise electrically connected to a substrate, such as too contacts on a printed circuit board. In such an arrangement, there are no interconnects extending from the ends 132 towards the substrate. Thus, one or both of the ends 132, or portions thereof, may be terminals, or self-terminating. The ends 132 may have a length of 0.5-2.0 mm, such as between 1.2-1.5 mm and/or a width of 0.2-2.0 mm, such as between 1.0-1.8 mm. The ends 132 may not have insulation to promote soldering to the substrate.

The ends 132 may (or may not) be connected to the feet 114. Such a connection may be through the use of an attachment portion or region attached to both a given end 132 and a corresponding foot 114. Such a connection may be with a weld. The ends 132 themselves (e.g., formed from a material such as copper) may provide the donating material for weld(s), and as such, no external material may be needed to form the weld. Other attachment portions may include a material that may first be applied to the feet 114 and/or the ends 132 before connecting the ends 132 with the feet 114. Exemplary materials include SAC solder, pure Sn, or Sn/Pb solder.

The ratio of turns of the primary winding 120 to the secondary winding 130 may be between 1:10 and 1:300. Therefore the transformer 100 is a step-up transformer that steps up the alternating current voltage (or more simply, “voltage”) across the primary winding 120 by a factor of ten to three-hundred (minus any non-ideal factors). For example, if the voltage across the primary winding 120 is a value between 0.002-0.020 V, such as between 0.008-0.012 V, the alternating current voltage across the secondary winding 130 will be stepped up to a corresponding value between 0.20-2.0 V, such as between 0.80-1.20 V. The voltage across the secondary winding 130 may not precisely reflect the turns ratio due to non-ideal conditions. Exemplary current flows in the primary winding 120 may be between 4-40 A, such as between 10-20 A. Corresponding current flows in the secondary winding 130 may be between 0.04-0.40 A, such as between 0.10-0.20 A depending on the load across the secondary winding 130. Exemplary loads are between ˜0-50Ω, such as between 10-20Ω. The transformer 100 may be configured to operate at frequencies, such as between 1 kHz-10 MHz, such as between 10 kHz-1 MHz.

According to embodiments, the transformer 100 can be constructed such that it has no upper portion 115 of the core 110 after completion. According to embodiments, the transformer 100 may be partially encased in an overmold (not shown) including material such as a magnetic composite material. In such an embodiment, the ends 132 and ends 121 may not be encased, such that the ends 121, 132 are still accessible to connect to a substrate, for example, as self-terminating terminals, as described herein. According to one embodiment, there is no upper portion 115, but there is a casing. According to another embodiment, there is an upper portion 115, but there is no casing (e.g., FIG. 1B). According to another embodiment, there is no upper portion 115 or casing (e.g., FIG. 1A). According to another embodiment, both the upper portion 115 and the casing are included.

The core 110 or portions thereof may be formed from different possible materials, such as ferrite or composite. Examples of such materials include carbonyl iron alloys, silicon iron chromium alloys, silicon iron aluminum alloys, nanocrystaline and amorphous materials, or other soft magnetic materials. The core 110 may be formed by pressing the material to a shape and then grinding the shape to a final, desired shape. When the upper portion 115 of the core 110 is included, the upper portion 115 may be formed separately from other portion(s) of the core 110.

Formation of the overmold (if included) may be different than formation of the core 110. For example, a core 110 may be formed by firing at relatively high temperature (e.g., over 800° C.). Such high temperature may increase magnetic properties of the core 110. In contrast, overmold material may be baked at relatively lower temperatures (e.g., 300°-500° F.) to form the overmold.

As shown in FIG. 6, the transformer 100 may be used in a circuit, such as a current sensing circuit. The circuit may be used to sense the current flowing through the primary Iₚ. Exemplary sources of such a current include an on-board charger, a battery pack, or a server power supply. A current Is will be induced across the secondary winding 130, which will flow through the resistor or load R. One exemplary application is a bi-directional DC-DC converter designed to charge a relatively low voltage (12 V) battery from a higher voltage battery bus (400/600 V) when operated in the forward direction, and to pre-charge the DC bus capacitor in the reverse direction. In this example, the DC-DC converter uses a peak current mode control (PCMC) technique. The transformer 100 may have a turns ratio of 1:100 turns ratio and is used for primary inductance current sensing for the PCMC control.

In the circuitry shown in FIG. 6, an exemplary resistance R is positioned across the secondary winding 130. The ideal voltage across the resistance R may be approximately determined according to the following equation for ideal conditions:

V=(Iₚ*R)/N

where N is the number of turns in the secondary winding 130.

The voltage V across the resistance R may reflect non-ideal conditions and tolerances of one or more components in the transformer 100. The voltage V may be measured by an analog-to-digital converter, or otherwise provided to additional circuitry not shown. The impedance of the additional circuitry may be relatively high compared to the resistance R, and as such, the additional circuitry may not significantly impact the load across the secondary winding 130.

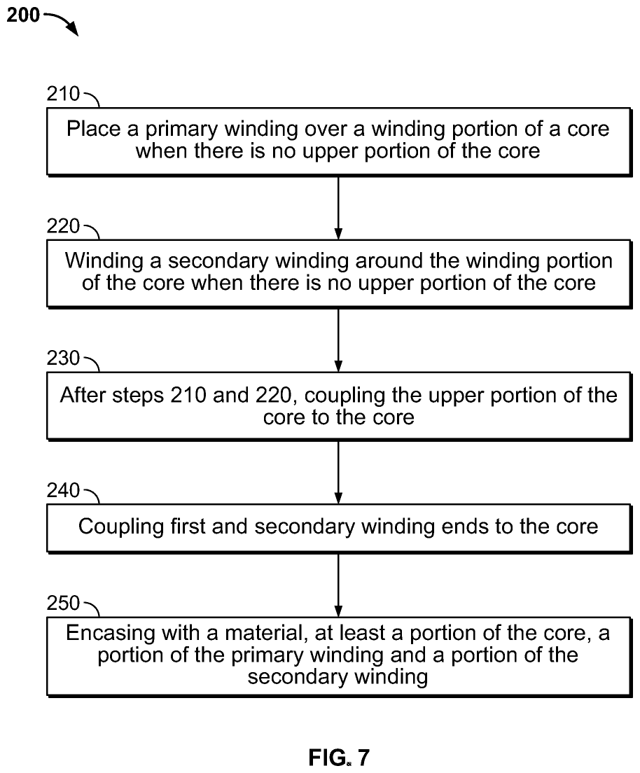

FIG. 7 illustrates a flowchart 200 for a method of constructing a transformer, according to embodiments. Reference will be made to transformer 100, but the method is not so-limited. Steps may be performed in a different order. For example, step 220 may be performed before step 210. Steps may be omitted, such as steps 240 and/or 250.

At step 210, the primary winding 120 is placed over the winding portion 111 of the core 110. The primary winding 120 may be placed over the winding portion 111 when there is no upper portion 115 attached to the remainder of the core 110. The ends 121 of the primary winding 120 may be terminals and self-terminating.

At step 220, the secondary winding 130 is wound around the winding portion 111 of the core 110, when there is no upper portion 115 of the core 110 attached to the core 110. In such a way, the use of a winding tool, such as a bobbin, to wind the wire of the secondary winding 130 may be avoided, thereby simplifying construction.

At step 230, the upper portion 115 of the core 110 is attached to the remainder of the core 110, for example, attached to the first lateral portion 112 and/or the second lateral portion 113. An adhesive or epoxy may be applied to any or all of the first lateral portion 112, the second lateral portion 113, or the upper portion 115. The attachment may result in a gap, e.g. a gap of 0.02-0.1 mm, between the adhered surface of the upper portion 115 and corresponding surfaces on the core 110.

At step 240, the first secondary winding end 132 and the second secondary winding end 132 are attached to the core 110 (e.g., to the feet 114 of the second lateral portion 113). The first secondary winding end 132 and the second secondary winding end 132 may be bare, uninsulated wire, which may be welded to the feet 114. The first secondary winding end 132 and the second secondary winding end 132 may be terminals and self-terminating.

At step 250, a portion of the transformer 100 is encased with an overmold including a material such as one or more of the ones discussed above. The lower region of the transformer 100 (e.g., the bottom surface) may not be encased, such that the primary winding ends 121 and the secondary winding ends 132 remain exposed for connection to a substrate.

It will be understood by those skilled in the art that various changes may be made and equivalents may be substituted without departing from the scope of the novel techniques disclosed in this application. In addition, many modifications may be made to adapt a particular situation or material to the teachings of the novel techniques without departing from its scope. Therefore, it is intended that the novel techniques not be limited to the particular techniques disclosed, but that they will include all techniques falling within the scope of the appended claims.

1. A transformer, comprising:
a core including a winding portion comprising a first end and a second end;
a primary winding proximate the first end of the winding portion of the core, wherein the primary winding includes a wire comprising a U-shape, a first primary winding end, and a second primary winding end, wherein the first primary winding end comprises a first primary terminal, and the second primary winding end comprises a second primary terminal; and
a secondary winding proximate the second end of the winding portion of the core, wherein the secondary winding includes a wire forming a plurality of turns, a first secondary winding end, and a second secondary winding end, wherein the first secondary winding end comprises a first secondary terminal, and wherein the second secondary winding end comprises a second secondary terminal.

2. The transformer of claim 1, further comprising a first lateral portion of the core and a second lateral portion of the core, a first attachment portion coupling the first secondary winding end to the second lateral portion of the core, and a second attachment portion coupling the second secondary winding end to the second lateral portion of the core.

3. The transformer of claim 2, wherein the first attachment portion and the second attachment portion comprise welds.

4. The transformer of claim 2, wherein the first primary winding end and the second primary winding end are not coupled with the core.

5. The transformer of claim 4, wherein the wire of the primary winding is substantially rigid.

6. The transformer of claim 1, wherein the plurality of turns of the wire of the secondary winding comprises between two and eight layers.

7. The transformer of claim 6, wherein the wire of the secondary winding comprises between 20 and 200 turns.

8. The transformer of claim 1, wherein the core further comprises a first lateral portion coupled with the first end of the winding portion, a second lateral portion coupled with the second end of the winding portion, and an upper portion, wherein the upper portion is coupled with the first lateral portion and the second lateral portion.

9. The transformer of claim 8, wherein:
a first gap is formed between the upper portion and the first lateral portion in a coupling region between the upper portion and the first lateral portion; and
a second gap is formed between the upper portion and the second lateral portion in a coupling region between the upper portion and the second lateral portion.

10. The transformer of claim 9 wherein the first gap and the second gap are each between 0.02-0.10 mm.

11. A method for constructing a transformer, the transformer including a core, wherein the core comprises a winding portion having a first end and a second end, a first lateral portion coupled with the first end of the winding portion, and a second lateral portion coupled with the second end of the winding portion, a primary winding, and a secondary winding, the method comprising:
placing a primary winding over a winding portion of the core proximate the first end of the winding portion, wherein the primary winding includes a wire including a U-shape, a first primary winding end, and a second primary winding end; and
winding a secondary winding around the winding portion of the core proximate the second end of the winding portion, wherein the secondary winding includes a wire forming a plurality of turns, a first secondary winding end, and a second secondary winding end,
wherein there is no upper portion of the core coupled with the first lateral portion and the second lateral portion when performing said placing the primary winding over the winding portion of the core and said winding the secondary winding around the winding portion of the core.

12. The method of claim 11, further comprising, after said placing the primary winding over the winding portion of the core, and after said winding the secondary winding around the winding portion of the core, coupling the upper portion of the core with the first lateral portion of the core, and coupling the upper portion of the core with the second lateral portion of the core.

13. The method of claim 12, wherein when the upper portion of the core is coupled with the first lateral portion of the core and the second lateral portion of the core, a first gap is formed between the upper portion of the core and the first lateral portion of the core, and a second gap is formed between the upper portion of the core and the second lateral portion of the core, wherein each of the first gap and the second gap is between 0.02 and 0.10 mm.

14. The method of claim 11, further comprising encasing, with an overmold, at least a portion of the core, a portion of the primary winding, and a portion of the secondary winding, wherein the first primary winding end, the second primary winding end, the first secondary winding end, and the second secondary winding end are not encased by the overmold.

15. The method of claim 14, wherein the overmold comprises a magnetic composite material.

16. The method of claim 11, further comprising coupling the first secondary winding end and the second secondary winding end with the second lateral portion of the core.

17. The method of claim 16, wherein said coupling the first secondary winding end and the second secondary winding end with the second lateral portion of the core comprises welding the first secondary winding end and the second secondary winding end to the second lateral portion of the core.

18. The method of claim 16, wherein the first primary winding end and the second primary winding end are not coupled with the core.

19. The method of claim 11, wherein said winding the secondary winding around the winding portion of the core comprises:
winding a first layer around the core; and
subsequently winding a second layer around the first layer.

20. The method of claim 11, wherein the wire of the primary winding is substantially rigid.
